(19) United States
(12) Patent Application Publication
(10) Pub. No.: US 2004/0254935 A1
(43) Pub. Date: Dec. 16, 2004

(54) Method and apparatus for automatic consolidation of personalized dynamic data

(75) Inventors: Bryan Christopher Chagoly, Austin, TX (US); Dustin C. Kirkland, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/460,424

(22) Filed: Jun. 12, 2003

(51) Int. Cl. G06F 17/30

(52) U.S. Cl. 707/10

(57) ABSTRACT

A method, apparatus, and computer instructions for retrieving content in a distributed data processing system. Steps performed to retrieve a plurality of Web pages in the distributed data processing system are identified. Content in the plurality of retrieved Web pages is selected by a user input. Data needed to retrieve the selected content in the plurality of retrieved Web pages is identified. A custom Web page is created in which the custom Web page contains instructions to retrieve the selected content. The selected content is retrieved using the instructions when the custom Web page is accessed.

### BACKGROUND OF THE INVENTION

1. Technical Field

The present invention relates generally to an improved data processing system and in particular, to a method and apparatus for processing data. Still more particularly, the present invention provides a method, apparatus, and computer instructions for recording user input during Web browsing actions to provide personalized dynamic data.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Many users typically visit the same Web sites on a daily basis. This information may include data that changes dynamically. For example, headlines and account balances may change on a daily basis. This information is referred to as dynamic data. Static data on a web page that does not change, such as disclaimers and copy right notices on a web page. Dynamic data is of interest to a user because this type of data often provides a user with up-to-date information, such as daily events, stock prices, and checking or savings balances.

For example, a user may visit one web site to view information, such as the balance of a checking account and a savings account. The user may visit another Web site to see information about a credit card. Another Web site may be visited to check stock prices. Additionally, a user may read headlines from a number of different Web sites. All of this dynamic information is located on different Web pages.

At each of these Web sites, a user may enter a user name and password to gain access to a site and select a number of different links until a user reaches the page containing the desired data. The user then reads the information and logs out. This process is followed for the different Web sites that a user may visit on a daily basis. When the user visits another Web site, the user typically logs out from the current Web site and enters a URL or selects a link to reach the next Web site. Alternatively, the user may leave the page with the desired information on the screen and initiate another instance of the browser to reach the next Web site. Such a situation may result in a clutter of windows on the user's screen.

To reach the pertinent or desired information, such as a balance, some numbers, or a few headlines, the user must select a number of different links to reach the desired page. Additionally, while traversing these pages, a user is exposed to numerous advertisements in the form of banners and pop-ups. Having to repeat these steps for every Web site on a daily basis can be time consuming to a user who is only looking for a specific piece of information.

Therefore, it would be advantageous to have an improved method, apparatus, and computer instructions for retrieving the desired information while avoiding requiring the user to traverse the different pages to reach the desired information.

### SUMMARY OF THE INVENTION

The present invention provides a method, apparatus, and computer instructions for retrieving content in a distributed data processing system. Steps performed to retrieve a plurality of Web pages in the distributed data processing system are identified. Content in the plurality of retrieved Web pages is selected by a user input. Data needed to retrieve the selected content in the plurality of retrieved Web pages is identified. A custom Web page is created in which the custom Web page contains instructions to retrieve the selected content. The selected content is retrieved using the instructions when the custom Web page is accessed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram of components used in selecting data to generate a custom Web page in accordance with a preferred embodiment of the present invention;

FIG. 5 is a diagram illustrating components used in accessing user selected content in accordance with a preferred embodiment of the present invention;

FIG. 6 is a diagram illustrating HTML code for a custom Web page in accordance with a preferred embodiment of the present invention;

FIG. 7 is a diagram illustrating a custom Web page in accordance with a preferred embodiment of the present invention;

FIG. 8 is a flowchart of a process for selecting content in accordance with a preferred embodiment of the present invention;

FIG. 9 is a flowchart of a process for creating a report in accordance with a preferred embodiment of the present invention; and

FIG. 10 is a flowchart of a process for presenting content to a user in accordance with a preferred embodiment of the present invention.

### DETAILED DESCRIPTION OF THE PREFERRED EMBODIMENT

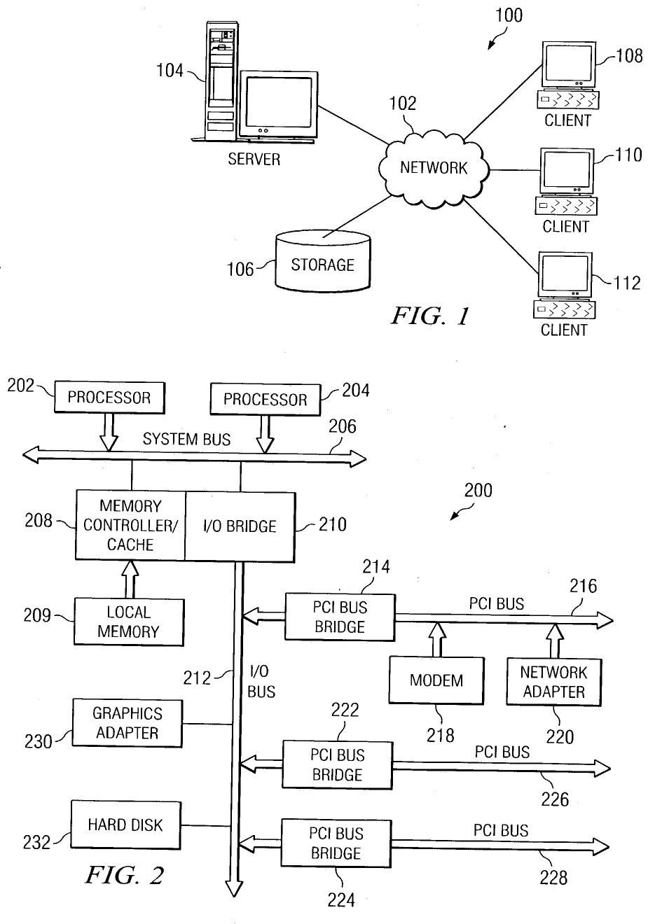

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

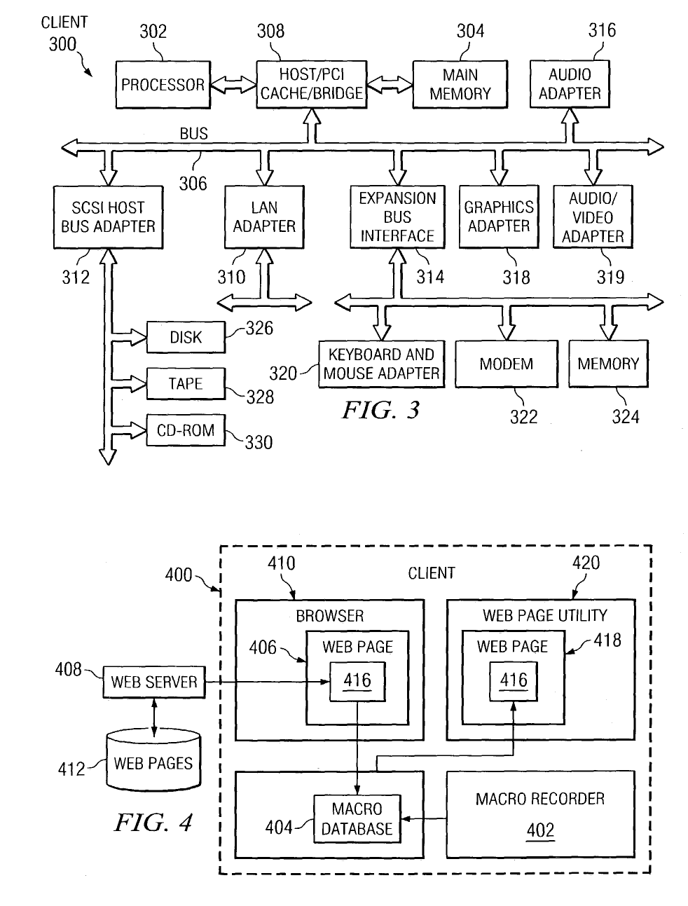

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent non-volatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for obtaining Web pages, distilling data in the Web pages down to the desired information, and preparing a report of the desired information. The report takes the form of a Web page in these examples. This Web page also includes links back to the original complete document.

Turning next to FIG. 4, a diagram of components used in selecting data to generate a custom Web page is depicted in accordance with a preferred embodiment of the present invention. Client 400 in FIG. 4 may be implemented in a data processing system, such as data processing system 300 in FIG. 3.

In these examples, a user may initiate a utility, such as macro recorder 402, to record input entered by the user to retrieve a Web page and select desired content. Macro recorder may be implemented using known processes for recording macros in these examples. This user input is stored in macro database 404. Macro recorder 402 may be implemented as a plug-in to the browser. The recording may be initiated through an extra button in a browser. Alternatively, macro recorder 402 may be designed as a small custom written browser designed exclusively for the purposes of recording web macros.

In either case, the user hits the record button and then performs all actions needed to reach the data that the user wants to obtain. This process starts with entering a first URL. Then, the user may select some number of links. The user input recorded by macro recorder 402 also may include, for example, entering account numbers, names, or passwords. The user may then select additional links. At some point, the user may highlight text or an image and presses a “select” button. The user can then perform any number of additional operations, such as logging out, before hitting the button to signify stopping recording.

At this point, the macro scans the HTML for the text or an image selected by the user. The macro recorder 402 scans the HTML code and finds a unique identifying string before and after the selected data, thereby delimitting the selected text. This identifying string may take various forms. For example, the string may be actual text that is displayed, a tag for a font type, or a tag for a font color. Identifying strings are stored in macro database 404 in these examples. The identifying strings are later used to parse out the selected content when the Web page is retrieved. Data for retrieving a particular Web page and the identifying strings for the selected content on the Web page are stored in association with an identifier in macro database 404. For example, the URL of the page may be used as the index to locate the data and identifying strings. Alternatively, some identifier, such as a unique identifier, may be used as the key to find the data needed to retrieve the Web page and parse out the selected content.

What is recorded by macro recorder 402 is all of the user input and data that defines how to obtain the data, not the data itself. The actual selected data is collected later at the runtime of the macro. The user also gives each macro a unique name, like “Whatever_Bank_Balance”, so the user can reference it later in the custom webpage.

In this example, the user has retrieved Web page 406 from server 408 for display in browser 410. Browser 410 may be implemented using available browsers, such as Microsoft Internet Explorer. Microsoft Internet Explorer is available from Microsoft Corporation. Web page 406 is served from Web pages database 412 in these examples. This database may be a database of static Web pages or may contain information and templates to dynamically generate Web pages.

All of the user input, used to obtain Web page 406, is recorded by macro recorder 402 in macro database 404. Macro database 404 includes all of the information needed to retrieve Web page 406 also is stored in macro database 404. This database represents all the information and instructions needed to retrieve Web page 406. The data stored in macros database 404 includes all of the information needed to retrieve Web page 406. This data includes, for example, cookies, post data, meta data, get data, and URLs. This data also may include user names and passwords, depending on the implementation. In some cases, a user may not want to have the macros save user name and password information.

In that case, when the macro is replayed, a prompt may be made for the user to input the user names and passwords for the different pages. Alternatively, the user names and passwords may be saved. The user may then assign a global user name and password. Replaying of the macro then causes a prompt for the global user name and password. Entry of this information allows for the stored user names and passwords to be used to retrieve the Web pages. All of this information is stored in association with a unique name to allow for selection of the macro at a later time.

Content 416 is represented by a macro stored in macro database 402. The macro recorded by the user in macro database 402 represents the processes needed to retrieve content 416.

A macro for the selected content, content 416, may then be placed into custom Web page 418 using Web page utility 420. In these examples, a graphical user interface may be used to present macros recorded by the user. These macros may be “dragged and dropped” into custom Web page 418 to place a macro to retrieve content 416 into custom Web page 418. The macro for content 416 may be, for example, a headline, or an account balance in Web page 406. Web page utility 420 may take various forms, for example, FrontPage from Microsoft Corporation.

The user may retrieve additional Web pages using macro recorder 404 to generate macros for use in custom Web page 418 in the manner described above. The user also may arrange these macros as desired. For example, the user may place macros for headlines from different Web pages at the top of custom Web page 418. Macros for financial content, such as checking account information and stock quotes, may be placed after the headlines. The user also may customize the presentation, such as, for example, font size, font color, and borders. Links are generated in custom Web page 418 to execute macros to retrieve content from Web pages and place the desired content into custom Web page 418 when this Web page is accessed by the user at a later time. In these examples, links are presented by macro tags as described in more detail below.

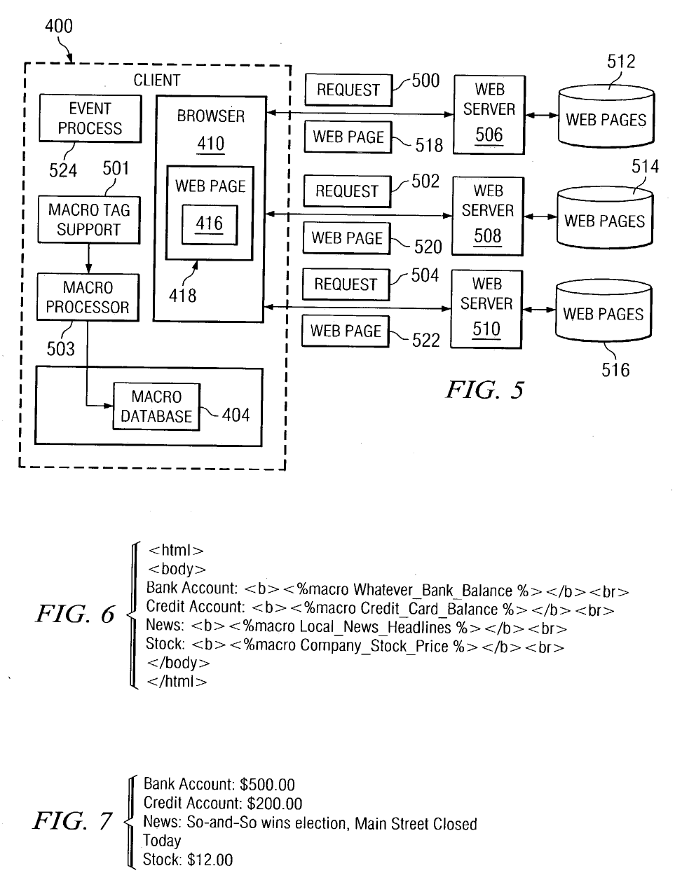

Turning next to FIG. 5, a diagram illustrating components used in accessing user selected content is depicted in accordance with a preferred embodiment of the present invention. As illustrated, the user may later access custom Web page 418 in browser 410 to view information that the user has selected from different Web pages. Macro tag support 501 is provided to allow for recognition and execution of macros. When a macro tag is identified, macro processor 503 is initiated to execute the macros stored in macro database 404. In these examples, macro processor 503 is a set of code that is similar to a web browser without a graphical interface. This component performs the actions described by a macro stored in macro database 404. These actions include, for example, retrieving pages at linked addresses, submitting data into forms, accepting cookies, transmitting cookies, eventually arriving at the desired page, and parsing out the desired data.

Macro tag support 501 provides support for executing macro tags within a browser. Macro tag support 501 may be implemented in various ways, such as, for example, plug-in to an existing browser, or as a special browser altogether. This component enables the browser to recognize the macro tags, execute the macros, and replace each macro tag with the data returned from each executed macro. This tag support also may be incorporated into graphical Web design utilities such as Microsoft Frontpage.

In response to accessing Web page 418, requests 500, 502, and 504, are sent to Web servers 506, 508, and 510. These Web servers return the appropriate Web pages from Web page databases 512, 514, and 516. In these examples, these requests are sent serially, one after another, as each macro is executed. Depending on the implementation, the macros could be executed in parallel if the Web browser is enabled or configured for such a process.

In these examples, Web pages 518, 520, and 522 are returned to browser 410. The execution of the macros causes the content selected by the user is parsed out of these Web pages and placed into custom Web page 418 for display in browser 410. The desired content is parsed out of Web pages 518, 520, and 522 using data from data 412. Specifically, the data in these examples are the identifying strings that were identified when the content was selected in a particular Web page.

The access that causes the data from different Web pages to be retrieved and placed into a report such as custom Web page 418 is initiated by a user input to access this Web page. Alternatively, a process, such as event process 524, may initiate the access to custom Web page 418. This process may be initiated in response to an event. The event may be periodic, such as daily at a predetermined time, or non-periodic, such as the occurrence of an event, for example when a data processing system boots up. With initiating access to the Web page daily at a time, such as 5:00 A.M., a report is ready for the user to review without requiring the user to wait for Web pages to be retrieved. This feature is especially useful with slow connections, such as a dial-up account using a telephone line.

With reference now to FIG. 6, a diagram illustrating HTML code for a custom Web page is depicted in accordance with a preferred embodiment of the present invention. Custom Web page 600 contains macro tags in lines 602, 604, 606, and 608. Line 602 contains a macro tag for a macro to obtain a bank balance, while line 604 contains a macro tag to obtain a credit card balance. Line 606 contains a macro tag for a headline. Line 608 contains a macro tag for a macro to obtain stock prices. These macros were generated using a macro recorder when the user retrieved the different Web pages. This Web page was created by the user selecting the different macros and placing them into custom Web page 600.

Turning now to FIG. 7, a diagram illustrating a custom Web page is depicted in accordance with a preferred embodiment of the present invention. Web page 700 is an example of a Web page that is displayed when macros for custom Web page 600 are executed.

As can be seen, line 700 includes a balance for a bank account, while line 702 includes a balance for a credit card account. Line 704 includes a headline, while line 706 contains a stock price. This information may include links to allow a user to see the entire page if the user selects the link.

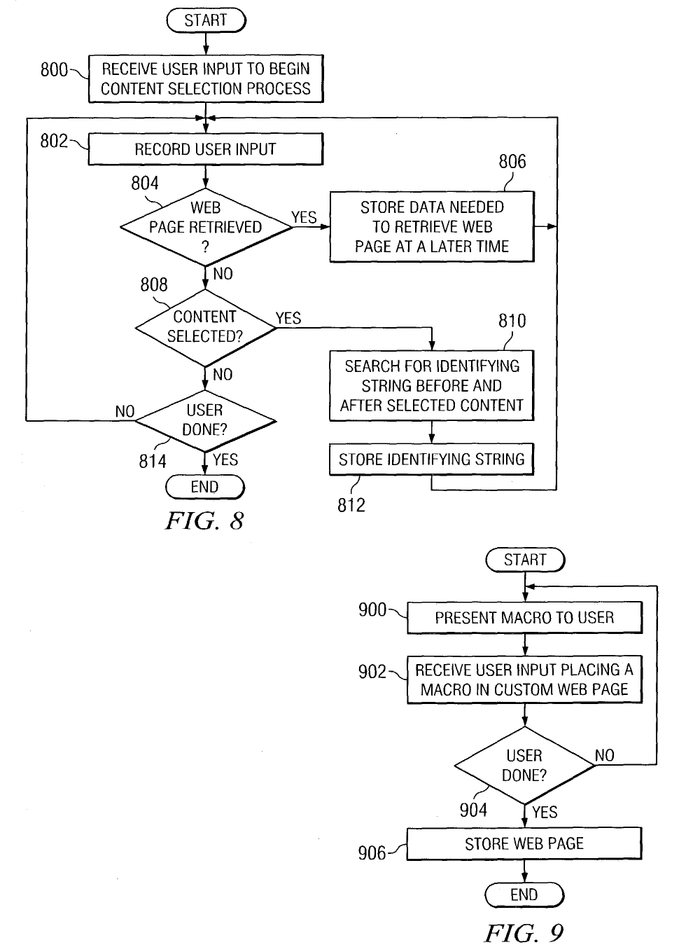

Turning next to FIG. 8, a flowchart of a process for selecting content is depicted in accordance with a preferred embodiment of the present invention. The process illustrated in FIG. 8 may be implemented in process, such as macro recorder 402 in FIG. 4.

The process begins by receiving user input to begin the content selection process (step 800). This user input is a selection of a command or button to start the macro recording process in these examples. Thereafter, user input is recorded (step 802). A determination is made as to whether the user input was input to retrieve a Web page (step 804). A user may select a Web page for retrieval in different ways. For example, the user may select a link on a Web page being displayed or enter a URL. If the user input is for retrieval of a Web page, data needed to retrieve the Web page is stored (step 806). Then, the process returns to step 802 to record additional user input.

Turning back to step 804, if the user input is not to retrieve a Web page, a determination is made as to whether the user input is input selecting content in a Web page (step 808). If the user input selects content in a Web page, a search for an identifying string before and after the selected content is made (step 810). The identifying string before the selected content may be different from the identifying string after the content. It is desirable to have a unique pair of identifying strings for the Web page to ensure that the correct content is later identified when the Web page is retrieved at a later time. The identifying string is stored for later use in identifying the desired content when the Web page is subsequently retrieved (step 812) with the process then returning to step 802 as described above. Depending on the implementation, the content itself is stored in addition to the identifying strings for use by the user in creating a report form, such as custom Web page 418 in FIG. 4.

In step 808, if content is not selected by the user input, a determination is made as to whether the user input indicates that the user is done selecting content (step 814). When a user is done selecting content, the user also might log out of the web site, which terminates the session on the server and clears cookies off the client. This additional step is often performed in addition to the selection of content and typically should be saved as part of the macro in these examples. If the user is done, the process terminates. Otherwise, the process returns to step 802 as described above.

With reference next to FIG. 9, a flowchart of a process for creating a report is depicted in accordance with a preferred embodiment of the present invention. The report form, in these examples, takes the form of a Web page.

The process begins by presenting the content to the user (step 900). The content is presented in a graphical user interface in these examples. In particular, graphical representations of the macros are presented to the user. These macros may be manipulated by the user to generate the report form desired by the user. User input is then received in which the user input places the macro in the custom Web page (step 902). The macro may be placed in the custom Web page through manipulations such as “drag and drop” operations.

A determination is then made as to whether the user is done placing macro in the custom Web page (step 904). If the user is not done placing content in the custom Web page, the process returns to step 900 as described above. Otherwise, the process terminates.

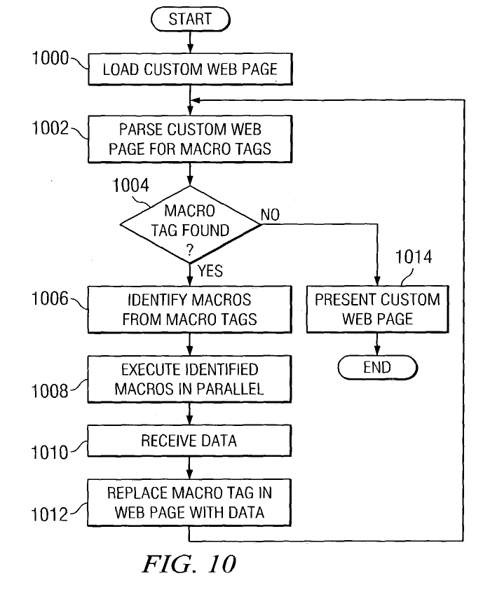

Turning next to FIG. 10, a flowchart of a process for presenting content to a user is depicted in accordance with a preferred embodiment of the present invention. The process illustrated in FIG. 10 may be implemented in process, such as browser 410 in FIG. 4. In these examples, Web browser 410 is enabled with a macro process and macro tag support, as described above in FIG. 5.

The process begins by loading the custom Web page (step 1000). The custom Web page is a Web page, such as custom Web page 418 in FIG. 4. The custom Web page is parsed for macro tags (step 1002). These macro tags are tags that refer or point to macros, such as macro database 404 in FIG. 4. A determination is then made as to whether a macro tag is found (step 1004). If a macro tag is found, the macros are identified from the macro tags (step 1006), and the identified macros are executed (step 1008). The macros include instructions for requesting Web pages containing the selected content for the custom Web page in these examples. The macros may be executed sequentially or in parallel, depending on the particular implementation.

Data is received in response to the execution of the macros (step 1010). This data is parsed by the macros in response to receiving Web pages requested by the macros. The data is the selected content in this example. Thereafter, the macro tag in the Web page is replaced with the data received from executing the macro (step 1012), with the process then returning to step 1002 as described above.

With reference again to step 1004 if a macro tag is not found, the all of the macro tags have been identified in the Web page. As a result, the custom Web page is then presented with the data (step 1014), with the process terminating thereafter.

In FIG. 10, the macros include the user names and passwords needed to retrieve the Web pages. This information could be secured by not including the user names and passwords as data provided by the macros. In such an implementation, the user may be prompted to enter the user names and passwords.

Thus, the present invention provides an improved method, apparatus, and computer instructions for retrieving desired user content from different remote sources in a network data processing system, such as the Internet. The mechanism of the present inventions allows for a user to avoid having to retrieve multiple pages to get to a desired page for a number of different Web sites. All of the selected content is presented in a report to the user. Links to the actual pages also are included in the report to allow the user to view the actual page if desired. The mechanism also avoids having to view advertisements that are embedded in the different Web pages.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the illustrations are described with respect to Web pages on the Internet, the mechanism of the present invention may be implemented to retrieve content from other sources, such as documents or files in a LAN or intranet. Also, the content may take different forms in addition to a Web page, such, as an audio file or a video file. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for retrieving content in a distributed data processing system, the method comprising:
identifying steps performed by a user to retrieve a plurality of Web pages in the distributed data processing system, wherein the plurality of Web pages are a plurality of retrieved Web pages;
receiving user input selecting the content in the plurality of retrieved Web pages;
identifying data needed to retrieve the selected content in the plurality of Web pages; and
creating a custom Web page containing instructions to retrieve the selected content, wherein the selected content is retrieved using the instructions when the custom Web page is accessed.

2. The method of claim 1 further comprising:
responsive to accessing the custom Web page, retrieving the selected content using the instructions to form retrieved content; and
presenting the custom Web page using the retrieved content.

3. The method of claim 1, wherein the retrieving step includes:
retrieving the plurality of Web pages; and
placing the selected content from the plurality of Web pages into the custom Web page.

4. The method of claim 1, wherein the data includes at least one of a universal resource locator, posted data, a password, and a cookie.

5. The method of claim 1, wherein the instructions are executed in response to a user input accessing the custom Web page.

6. A method in a data processing system for retrieving content, the method comprising:
recording user input used to retrieve a Web page to form a macro;
identifying data needed to retrieve the Web page;
selecting content in the Web page to form selected content; and
placing instructions in a new Web page, wherein the instructions are executable to retrieve the selected content.

7. The method of claim 6, wherein the recording, identifying, selecting, and placing steps are repeated to select content from additional Web pages, wherein the new Web page includes instructions to retrieve the selected content from the Web page and content from the additional Web pages.

8. A data processing system for retrieving content in a distributed data processing system, the data processing system comprising:
identifying means for identifying steps performed by a user to retrieve a plurality of Web pages in the distributed data processing system, wherein the plurality of Web pages are a plurality of retrieved Web pages;
receiving means for receiving user input selecting the content in the plurality of retrieved Web pages;
identifying means for identifying data needed to retrieve the selected content in the plurality of Web pages; and
creating means for creating a custom Web page containing instructions to retrieve the selected content, wherein the selected content is retrieved using the instructions when the custom Web page is accessed.

9. The data processing system of claim 8 further comprising:
retrieving means, responsive to accessing the custom Web page, for retrieving the selected content using the instructions to form retrieved content; and
presenting means for presenting the custom Web page using the retrieved content.

10. The data processing system of claim 9, wherein the retrieving means includes:
first means for retrieving the plurality of Web pages; and
second means for placing the selected content from the plurality of Web pages into the custom Web page.

11. The data processing system of claim 8, wherein the data includes at least one of a universal resource locator, posted data, a password, and a cookie.

12. The data processing system of claim 8, wherein the instructions are executed in response to a user input accessing the custom Web page.

13. A data processing system for retrieving content, the data processing system comprising:
recording means for recording user input used to retrieve a Web page to form a macro;
identifying means for identifying data needed to retrieve the Web page;
selecting means for selecting content in the Web page to form selected content; and
placing means for placing instructions in a new Web page, wherein the instructions are executable to retrieve the selected content.

14. The data processing system of claim 13, wherein the recording means, identifying means, selecting means, and placing means are repeatedly initiated to select content from additional Web pages, wherein the new Web page includes instructions to retrieve the selected content from the Web page and content from the additional Web pages.

15. A computer program product in a computer readable medium for retrieving content in a distributed data processing system, the computer program product comprising:
first instructions for identifying steps performed to retrieve a plurality of Web pages in the distributed data processing system, wherein the plurality of Web pages are a plurality of retrieved Web pages;
second instructions for receiving user input selecting the content in the plurality of retrieved Web pages;
third instructions for identifying data needed to retrieve the selected content in the plurality of Web pages; and
fourth instructions for creating a custom Web page containing instructions to retrieve the selected content, wherein the selected content is retrieved using the instructions when the custom Web page is accessed.

16. A computer program product in a computer readable medium for retrieving content, the computer program product comprising:
first instructions for recording user input used to retrieve a Web page to form a macro;
second instructions for identifying data needed to retrieve the Web page;
third instructions for selecting content in the Web page to form selected content; and
fourth instructions for placing instructions in a new Web page, wherein the instructions are executable to retrieve the selected content.

17. A data processing system comprising:
a bus system;
a memory connected to the bus system, wherein the memory includes a set of instructions; and
a processing unit connected to the bus system, wherein the processing unit executes the set of instructions to identify steps performed to retrieve a plurality of Web pages in the distributed data processing system, wherein the plurality of Web pages are a plurality of retrieved Web pages; receive user input selecting content in the plurality of retrieved Web pages; identify data needed to retrieve the selected content in the plurality of Web pages; and create a custom Web page containing instructions to retrieve the selected content, wherein the selected content is retrieved using the instructions when the custom Web page is accessed.

18. A data processing system comprising:
a bus system;
a memory connected to the bus system, wherein the memory includes a set of instructions; and
a processing unit connected to the bus system, wherein the processing unit executes the set of instructions to record user input used to retrieve a Web page to form a macro; identify data needed to retrieve the Web page; select content in the Web page to form selected content; and place instructions in a new Web page, wherein the instructions are executable to retrieve the selected content.
